(19) United States
(12) Patent Application Publication
(10) Pub. No.: US 2004/0141079 A1
(43) Pub. Date: Jul. 22, 2004

(54) Solid-state imaging device and camera using the same

(75) Inventors: Takumi Yamaguchi, Kyoto-shi (JP); Takahiko Murata, Osaka-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Osaka (JP)

(21) Appl. No.: 10/754,403

(22) Filed: Jan. 9, 2004

(30) Foreign Application Priority Data
Jan. 10, 2003 (JP) 2003-004857

(51) Int. Cl. H04N 5/335

(52) U.S. Cl. 348/308

(57) ABSTRACT

A solid-state imaging device includes: an imaging region in which a plurality of pixels are arranged; and a signal line through which a signal of the imaging region is read out. An adding circuit for adding pixel signals obtained from two or more of the pixels is provided so that an output signal of the adding circuit is read out to the signal line. On the basis of a predetermined reference quantity of light incident onto the imaging region, a gain of the adding circuit in a condition in which a quantity of the incident light is above the reference quantity is controlled to be smaller than a gain of the adding circuit in a condition in which a quantity of the incident light is below the reference quantity. High sensitivity can be obtained with an adding circuit, and saturation of the adding circuit in large quantity of light can be suppressed, obtaining a wide dynamic range.

### FIELD OF THE INVENTION

The present invention relates to a solid-state imaging device in which a plurality of pixels are arranged for photoelectric conversion of incident light and relates to a camera such as a digital camera on which the solid-state imaging device is mounted.

### BACKGROUND OF THE INVENTION

Solid-state imaging devices output photoelectrically converted signals of a plurality of unit pixels as image signals, and therefore are known as being applicable as an image input element constituting mobile equipment such as a digital still camera.

FIG. 5 shows a configuration example of a conventional solid-state imaging device equipped with an adding circuit (See JP 09(1997)-247535 A, for example). This solid-state imaging device includes: an imaging region 2 in which a plurality of pixels 1 are arranged two-dimensionally; a vertical shift register 3 for selecting pixels; a row selection line 4; a vertical signal line 5; an adding circuit 6; a horizontal shift register 7; a horizontal signal line 8 and an output amplifier 9.

In the imaging region 2, the vertical shift register 3 selects each row selection line 4 sequentially and signals of pixels 1 in each row are read out to the vertical signal line 5, which are input into the adding circuit 6 to be added as image signals and stored in a capacitor or the like. Thereafter, the signal stored in each adding circuit 6 is selected sequentially by the horizontal shift register 7 so as to be read out as an added signal to the horizontal signal line 8, which is output from the output amplifier 9.

In the solid-state imaging device equipped with the adding circuit 6, a plurality of pixel signals are added so as to increase the signal quantity, whereby a high-sensitivity image can be obtained, even when an quantity of incident light is small and so each pixel signal has a small signal quantity. Although adding the plurality of pixel signals might degrade the resolution, the number of pixel signals to be read out to the output amplifier 9 can be decreased, thus decreasing a time required for reading out one frame and increasing the speed of the operation of the solid-state imaging device.

As described above, the solid-state imaging device equipped with the adding circuit has the features of obtaining high sensitivity and high speed by adding and storing a plurality of pixel signals. In the conventional solid-state imaging device equipped with the adding circuit, since a large area is allocated for the adding circuit 6, signals of a plurality of pixels 1 simply can be added for storing the signals in the capacitor or the like of the adding circuit 6.

In recent years, however, as solid-state imaging devices have been increasingly miniaturized, a horizontal pitch of pixels has been narrowed to 6 μm or less and further to 4.5 μm or less. Accordingly, a storage area such as a capacitor of the adding circuit has been reduced. Furthermore, a trend to lower an operation voltage causes a decrease in a voltage that can be stored in a capacitor or the like to 3 V or less and further to 1.8 V or less, thus restricting a maximum voltage. For that reason, in the solid-state imaging device equipped with the adding circuit, if a large quantity of signal charge is generated by a large quantity of light applied thereto due to high illuminance and a plurality of pixel signals simply are added, it becomes possible that the added signals cannot be stored within the voltage range of the capacitor. That causes a problem of a deterioration of a dynamic range, so that adding of signals in a large quantity of incident light becomes disabled.

### SUMMARY OF THE INVENTION

Therefore, with the foregoing in mind, it is an object of the present invention to provide a solid-state imaging device by which high sensitivity can be obtained with an adding circuit, and an inability of the operation to add signals in large quantity of incident light can be avoided, resulting in the adding circuit with a wide dynamic range, and to provide a camera using such solid-state imaging device.

A solid-state imaging device of the present invention includes: an imaging region in which a plurality of pixels are arranged; and a signal line through which a signal of the imaging region is read out. In order to cope with the above-stated problems, an adding circuit for adding pixel signals obtained from two or more of the pixels is provided so that an output signal of the adding circuit is read out to the signal line. On the basis of a predetermined reference quantity of light incident onto the imaging region, a gain of the adding circuit in a condition in which a quantity of the incident light is above the reference quantity is controlled to be smaller than a gain of the adding circuit in a condition in which a quantity of the incident light is below the reference quantity.

### BRIEF DESCRIPTION OF THE DRAWINGS

FIG. 1 shows the overall configuration of a solid-state imaging device in Embodiment 1 of the present invention.

FIG. 2 shows a configuration of a main part in an imaging region of a solid-state imaging device in Embodiment 2 of the present invention.

FIG. 3 shows the overall configuration of a solid-state imaging device in Embodiment 3 of the present invention.

FIG. 4 shows a configuration of a main part in an imaging region of a solid-state imaging device in Embodiment 4 of the present invention.

FIG. 5 shows a configuration of a conventional solid-state imaging device equipped with an adding circuit.

### DESCRIPTION OF THE PREFERRED EMBODIMENTS

The solid-state imaging device of the present invention includes an adding circuit for adding signals of two or more pixels. In a condition of a small quantity of incident light in which the quantity of incident light is below the reference quantity, a gain of the adding circuit is made large, so that the sensitivity in a small quantity of light can be increased. In a condition of a large quantity of incident light in which the quantity of incident light is larger than the reference quantity, a gain of the adding circuit is made small. Thereby, a dynamic range in a large quantity of light can be widened.

Another solid-state imaging device of the present invention includes the adding circuit similar to that in the above-mentioned configuration, and within at least a partial range of a quantity of incident light onto the imaging region, a gain of the adding circuit is controlled to decrease with an increase of the quantity of the incident light.

With this configuration, as the quantity of light increases, the gain is decreased continuously, whereby a further wider dynamic range can be obtained. In addition, the continuous change of the gain improves a quality of an image at a border portion between pixel signals with different gains, thus obtaining a high quality of image.

In the above-mentioned configurations, the adding circuit may be arranged between the imaging region and the signal line.

In the above-mentioned configurations, a plurality of the adding circuits may be arranged between the two or more pixels included in the respective sets of pixels. Thereby, the adding circuit is provided between the pixels within the imaging region, and a gain is controlled within the imaging region in accordance with the quantity of light. Therefore, a signal processing can be operated without being out of a dynamic range of an input portion of other circuits (e.g., amplification circuit) outside of the imaging region, and a dynamic range of the solid-state imaging device as a whole can be increased.

It is preferable in the above-mentioned configurations that a plurality of the adding circuits are provided, and gains for at least two of the plurality of adding circuits are controlled individually. With this configuration, the gain can be adjusted for individual partial regions in the imaging region. Thereby, a dynamic range for each partial region in the imaging region can be expanded, resulting in a further higher image quality.

The above-mentioned solid-state imaging device may be provided with a photometer portion between the imaging region and the signal line so as to detect a quantity of the incident light onto the imaging region. A gain of the adding circuit may be controlled in accordance with a detection output from the photometer portion.

Alternatively, the above-mentioned solid-state imaging device may be provided with a photometer portion arranged between the two or more pixels included in each of the sets of pixels, so as to detect an quantity of incident light onto the two or more pixels. A gain of the adding circuit may be controlled in accordance with a detection output from the photometer portion.

With these configurations, the provision of the photometer portion in the solid-state imaging device allows rapid and direct adjustment of the supply of the gain of the adding circuit. Therefore, a high-speed processing and a high quality of image signal resulting from the improvement in the accuracy of the gain control can be obtained easily.

In the above-mentioned configurations, the adding circuit may be provided with an averaging portion for averaging pixel signals obtained from two or more of the pixels, and when the quantity of incident light is larger than a predetermined higher reference quantity that is larger than the reference quantity, an output of the averaging portion is read out to the signal line in place of the added signal.

In any one of the above-mentioned configurations, when signals of N pieces of pixels are added, a gain of the adding circuit is controlled so that an output value from the adding circuit is not more than a value obtained from the following formula: (value obtained by adding the N pieces of signals)/N.

With this configuration, a capacitor for storing signal in the adding circuit stores a signal of a quantity not more than a quantity corresponding to one pixel. Therefore, one capacitor may be used both for storing a signal of one pixel in the usual case where adding is not carried out and for storing a signal in the adding circuit, thus obtaining the miniaturization of the circuit.

Also, in any one of the above-mentioned configurations, when signals of N pieces of pixels are added, a gain of the adding circuit is controlled so that an output value from the adding circuit is less than a value obtained by adding the N pieces of signals and more than a value obtained from the following formula: (value obtained by adding the N pieces of signals)/N.

This configuration can cope with the problem of the saturation of the adding circuit when signals of N pieces of pixels are simply added, whereby the capacitor that stores signals in the adding circuit can be made smaller. In addition, by adding signals so as to increase the output voltage larger than the output voltage of one pixel, an image quality with high sensitivity is obtained.

A camera may be configured so as to include the solid-state imaging device having any one of the above-stated configurations.

The following describes embodiments of the present invention, with reference to the drawings.

### Embodiment 1

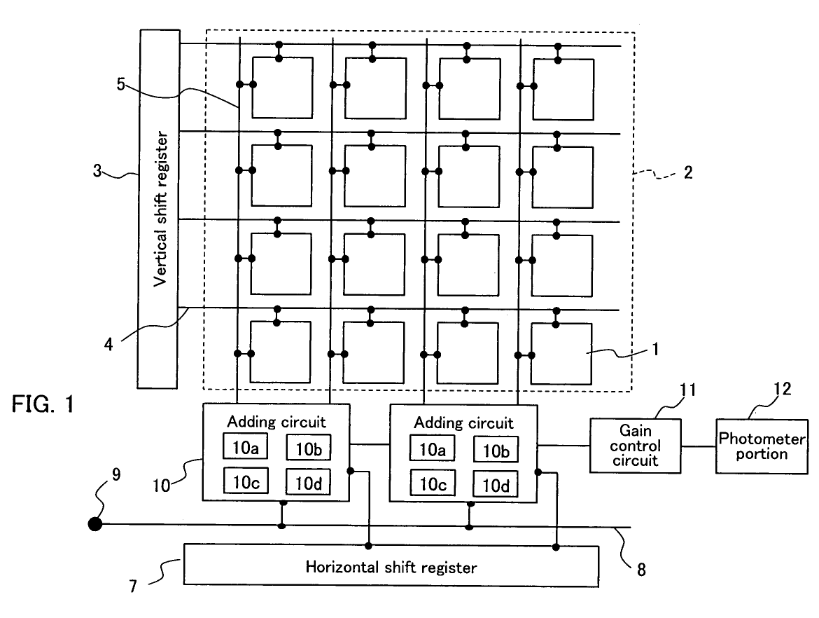

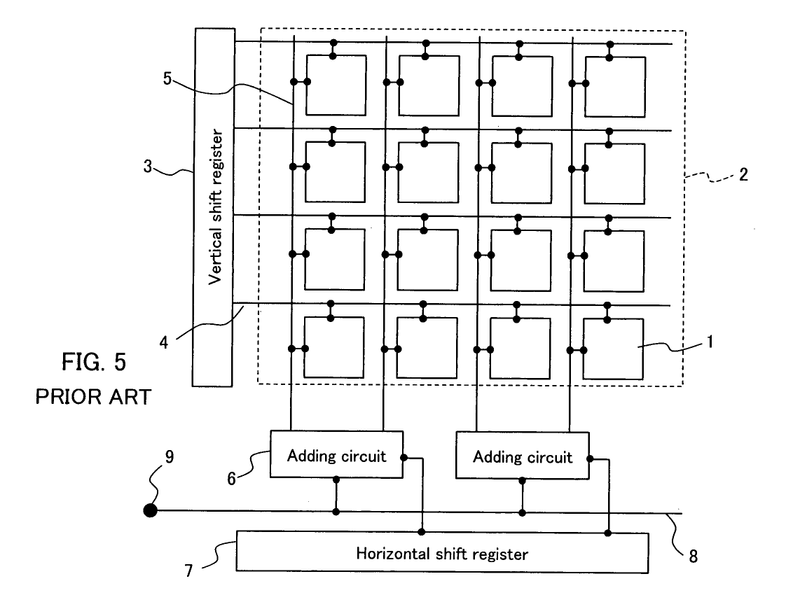

FIG. 1 shows the overall configuration of a solid-state imaging device in Embodiment 1 of the present invention. In FIG. 1, the same reference numerals are assigned to elements similar to those in the conventional example of FIG. 5 for the simplification of description. This solid-state imaging device is different from the conventional example of FIG. 5 in that an adding circuit 10 whose gain is adjustable is provided between an imaging region 2 and a horizontal signal line 8. Gains of the adding circuits 10 are controlled based on a gain control signal output from an overall gain control circuit 11. The overall gain control circuit 11 generates the gain control signal based on an output signal of the photometer portion 12. The photometer portion 12 detects directly or indirectly a quantity of light incident onto the imaging region 2.

The adding circuit 10 includes an adding portion 10a, an averaging portion 10b, a gain control portion 10c, and storage portion 10d. The adding portion 10a has a function of adding signals of the two pixels, and the averaging portion 10b has a function of averaging signals of the two pixels. They are supplied with signals of the two pixels. The gain control portion 10c controls a gain of the output of the adding portion 10a or the averaging portion 10b. The storage portion 10d has a function of storing an output signal of the adding portion 10a or the averaging portion 10b with a capacitor.

In the adding circuit 10, firstly, adding or averaging is carried out for two pixels on the same row out of signals of two columns, then a gain is controlled with the gain control signal from the overall gain control circuit 11, and finally signals are stored in the capacitor within the adding circuit 10. The following describes a specific example of controlling a gain.

In a condition of a low illuminance in which a quantity of incident light onto the imaging region 2 is small, signals from the pixels have low intensity, so that signals of the two pixels can be added directly in the adding circuit 10. In addition, even when a gain of the adding circuit 10 is increased, a capacitance of the capacitor in the adding circuit 10 is sufficient to be capable of storing such a signal. Therefore, in a condition of a low illuminance, a highly sensitive output can be obtained.

In a condition of a high illuminance in which a quantity of incident light onto the imaging region 2 is large, signals from the pixels have high intensity, so that there is an increased possibility of out-of-range of the capacitor when signals of the two pixels are added in the adding circuit 10. To avoid this, a gain of the adding circuit 10 is reduced, so that the capacitor within the adding circuit 10 can store the added signal for a large quantity of incident light so as not to saturate the capacitor. Thus, even in a condition of a high illuminance, pixel signals can be extracted accurately without the saturation of the circuit, and therefore a wide dynamic range can be obtained.

In a condition in which a quantity of incident light onto the imaging region 2 is so large that the gain control is insufficient to avoid the saturation, the averaging portion 10b functions in place of the adding portion 10a. The signals of the two pixels are averaged by the averaging portion 10b, so that the capacitor within the adding circuit 10 can store the added signal so as not to saturate the capacitor. Thus, a further wide dynamic range can be obtained.

In the above-mentioned configuration, the averaging portion 10b is not indispensable. The adding circuit 10 without the averaging portion 10b has a practically sufficient ability to suppress the saturation of the circuit.

The gain control by the gain control portion 10c may be applied to signals before being input to the adding portion 10a or the averaging portion 10b.

In the above configuration, the overall output gain of the adding circuit 10 is determined by (an added value)×(a gain for adjustment), and a wide dynamic range is obtained by switching the overall output gain between a small quantity of light and a large quantity of light. Alternatively, the overall output gain may be varied continuously in accordance with the respective incident quantities of light. Such continuous adjustment of the gain improves a quality of an image at a border portion between pixel signals with different gains, thus obtaining a high quality of image. The continuous adjustment of the gain is not necessarily performed in a whole range of a quantity of light incident onto the imaging region 2. Practically sufficient effect can be obtained by performing the continuous adjustment of the gain in at least a partial range of a quantity of light incident onto the imaging region 2.

Also, in the above configuration, the overall gain is adjusted externally with respect to all of the adding circuits 10 collectively. On the other hand, a gain may be adjusted for each of the adding circuits 10 individually. Thereby the gain can be adjusted for each partial region in the imaging region 2. Therefore, a dynamic range for each partial region in the imaging region 2 can be expanded, which leads to a further higher image quality. As an example of a configuration capable of adjusting a gain for each adding circuit 10, the output of the photometer portion 12 may be input directly to the adding circuits 10 so as to generate a gain control signal in the gain control portion 10c.

### Embodiment 2

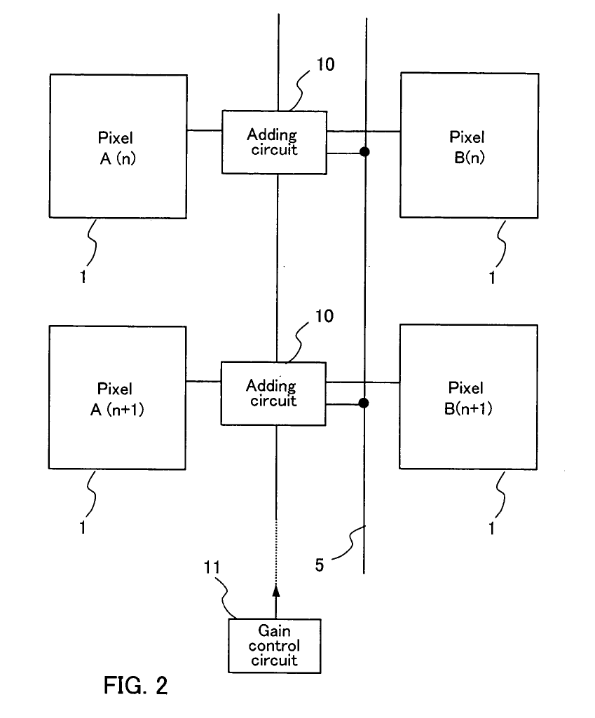

FIG. 2 shows a configuration of a part in an imaging region of a solid-state imaging device in Embodiment 2 of the present invention. This device is provided with the adding circuit 10 between a pixel A(n) and a pixel B(n) in an imaging region 2 and is configured so as to control a gain within the imaging region 2 in accordance with a gain control signal from the overall gain control circuit 11.

This configuration allows a signal processing in an input portion of the external circuit, e.g., amplifier circuit, provided outside of the imaging region 2 to be carried out without being out of a dynamic range of the circuit. Therefore a dynamic range of the solid-state imaging device as a whole can be increased.

It is possible to supply the output of the photometer portion 12 directly to the adding circuits 10 so as to generate a gain control signal in the adding circuits 10.

### Embodiment 3

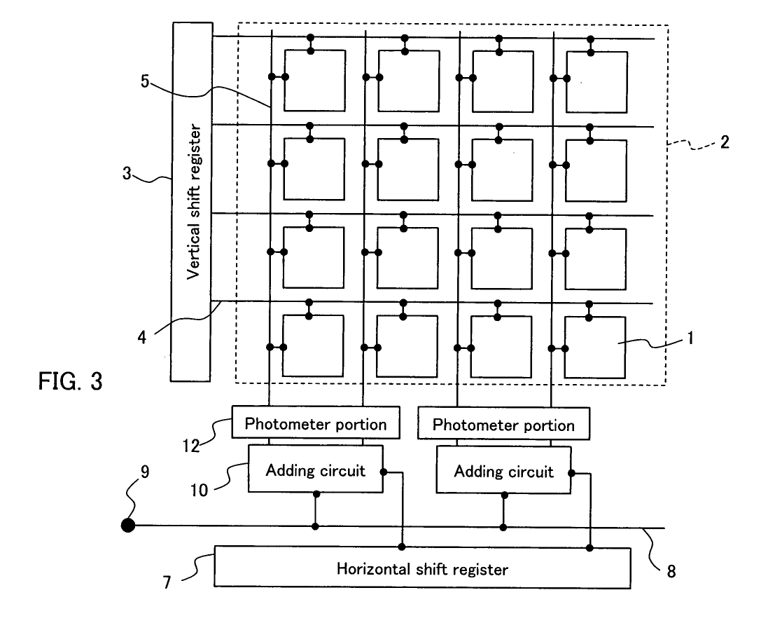

FIG. 3 shows the overall configuration of a solid-state imaging device in Embodiment 3 of the present invention. In contrast to the configuration of FIG. 1, this device is provided with a photometer portion 12 between an imaging region 2 and an adding circuit 10. The provision of the photometer portion 12 in the solid-state imaging device allows an overall gain of the adding circuit 10 to be obtained instantaneously and supplied directly to the adding circuit 10. Therefore, a high-speed processing and a high quality of image signal resulting from the improvement in the accuracy of the gain control can be obtained easily.

### Embodiment 4

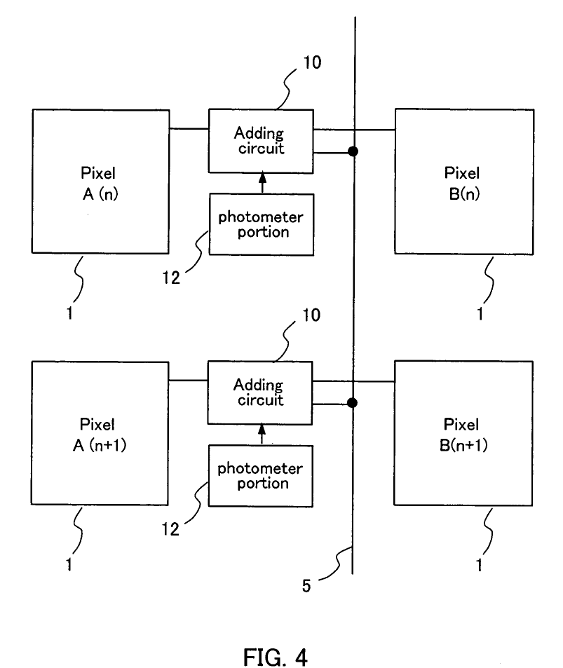

FIG. 4 shows a configuration of a part of an imaging region of a solid-state imaging device in Embodiment 4 of the present invention. In this device, the adding circuit 10 and the photometer portion 12 are provided between a pixel A(n) and a pixel B(n) in an imaging region 2. Thereby, instantaneously after the photometer portion 12 detects a light quantity, an overall gain of the adding circuit 10 is adjusted within the imaging region 2. According to this configuration, the highest speed for the overall gain adjustment can be obtained, and also the most improved accuracy of the gain adjustment can be obtained, thus achieving a further higher quality of image.

In the above-mentioned embodiment, a control of a gain of the adding circuit 10 may be carried out as follow:

A first example is that when signals of N pieces of pixels 1 are added, a gain of the adding circuit 10 is controlled so that an output value from the adding circuit 10 is not more than a value obtained from the following formula: (value obtained by adding the N pieces of signals)/N.

When the gain of the adding circuit 10 is equal to 1/N, an output voltage supplied to a capacitor that stores signals of the adding circuit 10 is obtained by adding signals of N pieces of pixels and then multiplying the result by the gain of 1/N, that is, the output voltage becomes equal to M volt (=(N×M)×1/N), where an output voltage from each pixel is M volt. Therefore, it is sufficient that the capacitor has a capacitance corresponding to the output voltage M of one pixel. If the gain is not more than 1/N, the capacitor stores a signal of a quantity not more than a signal quantity corresponding to one pixel. Therefore, one capacitor may be used both for storing a signal of one pixel in the usual case where adding is not carried out and for storing a signal in the adding circuit, thus obtaining the miniaturization of the circuit.

A second example is that when signals of N pieces of pixels 1 are added, a gain of the adding circuit 10 is controlled so that an output value from the adding circuit 10 is less than a value obtained by adding the N pieces of signals and more than a value obtained from the following formula: (value obtained by adding the N pieces of signals)/N.

Such control of a gain can cope with the problem of the saturation of the adding circuit 10 when the output voltage is increased to (N×M) due to simple addition of signals of N pieces of pixels 1, where the output from each pixel is M volt. That is to say, this manner of control can make the output from the adding circuit 10 smaller than (N×M). Thereby, the capacitor that stores signals in the adding circuit 10 can be made smaller. In addition, by adding signals so as to increase the output voltage larger than (N×M)/N, that is, larger than the output voltage of one pixel, an image quality with high sensitivity can be obtained.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A solid-state imaging device, comprising: an imaging region in which a plurality of pixels are arranged; and a signal line through which a pixel signal of the imaging region is read out,
wherein an adding circuit for adding pixel signals obtained from two or more of the pixels is provided so that an output signal of the adding circuit is read out to the signal line, and
wherein on the basis of a predetermined reference quantity of light incident onto the imaging region, a gain of the adding circuit in a condition in which a quantity of the incident light is above the reference quantity is controlled to be smaller than a gain of the adding circuit in a condition in which a quantity of the incident light is below the reference quantity.

2. A solid-state imaging device, comprising: an imaging region in which a plurality of pixels are arranged; and a signal line through which a signal of the imaging region is read out,
wherein an adding circuit for adding pixel signals obtained from two or more of the pixels is provided so that an output signal of the adding circuit is read out to the signal line, and
wherein, within at least a partial range of a quantity of incident light onto the imaging region, a gain of the adding circuit is controlled to decrease with an increase of the quantity of the incident light.

3. The solid-state imaging device according to claim 1 or 2, wherein the adding circuit is arranged between the imaging region and the signal line.

4. The solid-state imaging device according to claim 1 or 2, wherein a plurality of the adding circuits are arranged between the two or more pixels included in the respective sets of pixels.

5. The solid-state imaging device according to claim 1 or 2, wherein a plurality of the adding circuits are provided, and gains for at least two of the plurality of adding circuits are controlled individually.

6. The solid-state imaging device according to claim 3, wherein a photometer portion is provided between the imaging region and the signal line so as to detect a quantity of the incident light onto the imaging region, and a gain of the adding circuit is controlled in accordance with a detection output from the photometer portion.

7. The solid-state imaging device according to claim 4,
wherein a photometer portion is arranged between the two or more pixels included in each of the sets of pixels, so as to detect an quantity of incident light onto the two or more pixels, and
wherein a gain of the adding circuit is controlled in accordance with a detection output from the photometer portion.

8. The solid-state imaging device according to claim 1 or 2, wherein the adding circuit is provided with an averaging portion for averaging pixel signals obtained from two or more of the pixels, and when the quantity of incident light is larger than a predetermined higher reference quantity that is larger than the reference quantity, an output of the averaging portion is read out to the signal line in place of the added signal.

9. The solid-state imaging device according to claim 1 or 2, wherein when signals of N pieces of pixels are added, a gain of the adding circuit is controlled so that an output value from the adding circuit is not more than a value obtained from the following formula:
(value obtained by adding the N pieces of signals)/N.

10. The solid-state imaging device according to claim 1 or 2, wherein when signals of N pieces of pixels are added, a gain of the adding circuit is controlled so that an output value from the adding circuit is less than a value obtained by adding the N pieces of signals and more than a value obtained from the following formula:
(value obtained by adding the N pieces of signals)/N.

11. A camera equipped with the solid-state imaging device according to claim 1 or 2.
